(19) United States
(12) Patent Application Publication
(10) Pub. No.: US 2025/0381782 A1
(43) Pub. Date: Dec. 18, 2025

(54) DROPLET EJECTION APPARATUS, DROPLET EJECTION APPARATUS CONTAMINATION SUPPRESSING METHOD, AND STORAGE MEDIUM

(71) Applicant: Konica Minolta, Inc., Tokyo (JP)

(72) Inventors: Yousuke TAKASHIMA, Tokyo (JP); Hiroyuki TOKIMATSU, Tokyo (JP)

(21) Appl. No.: 19/229,478

(22) Filed: Jun. 5, 2025

(30) Foreign Application Priority Data
Jun. 12, 2024 (JP) 2024-094775

(51) Int. Cl. B41J 2/175; B41J 2/20; C09D 11/101; C09D 11/30

(52) U.S. Cl. CPC B41J 2/17566; B41J 2/20; C09D 11/101; C09D 11/30

(57) ABSTRACT

A droplet ejection apparatus includes: a plurality of tanks that store liquid; a droplet ejection head that ejects droplets; a liquid channel that communicates between a first tank and a second tank on a downstream side of the first tank in a liquid delivery direction; a liquid deliverer that delivers liquid from the first tank to the second tank; and a hardware processor that controls a liquid delivery speed of the liquid deliverer in accordance with an air amount present in the liquid channel and the second tank or an equivalent value equivalent to the air amount.

### CROSS-REFERENCE TO RELATED APPLICATIONS

The entire disclosure of Japanese Patent Application No. 2024-094775, filed on Jun. 12, 2024, is incorporated herein by reference in its entirety.

### BACKGROUND OF THE INVENTION

### Technical Field

The present invention relates to a droplet ejection apparatus, a droplet ejection apparatus contamination suppressing method, and a storage medium.

### Description of Related Art

Conventionally, a droplet ejection apparatus that ejects droplets from a droplet ejection head is known. The droplet ejection apparatus includes a plurality of tanks containing liquid. The tank is provided with, for example, a float switch as a measurement section for measuring a liquid level height of the liquid.

However, if air is present in the liquid channel, for example, when the liquid has not been fed through the supply channel, the liquid foams in the tank. When the liquid foams, a density decreases, and thus a buoyancy acting on the measurement section decreases. As a result, the measurement section may erroneously detect the liquid level height.

Therefore, for example, Japanese Unexamined Patent Publication No. 2006-123365 discloses a liquid level detection method in which detection of the liquid level height is performed a plurality of times for the purpose of suppressing erroneous detection of the remaining amount of ink due to generation of bubbles.

However, the problem caused by the bubbling of the liquid in the tank is not limited to the erroneous detection of the liquid level height. When the liquid foams in the tank, liquid splash occurs, which may contaminate an air channel provided in the tank. Therefore, it is required to suppress the foaming of the liquid itself rather than suppressing the influence due to the foaming of the liquid as in Japanese Unexamined Patent Publication No. 2006-123365.

### SUMMARY OF THE INVENTION

The present invention has been made in view of such circumstances. An object of the present invention is to provide a droplet ejection apparatus, a method of suppressing contamination of the droplet ejection apparatus, and a storage medium including a program that are capable of suppressing foaming of liquid in a tank.

In order to solve the above-described problem, according to one aspect of the present invention, a droplet ejection apparatus reflecting one aspect of the present invention includes,
a plurality of tanks that store liquid;
a droplet ejection head that ejects droplets;
a liquid channel that communicates between a first tank and a second tank on a downstream side of the first tank in a liquid delivery direction;
a liquid deliverer that delivers liquid from the first tank to the second tank; and
a hardware processor that controls a liquid delivery speed of the liquid deliverer in accordance with an air amount present in the liquid channel and the second tank or an equivalent value equivalent to the air amount.

According to another aspect of the present invention, a droplet ejection apparatus contamination suppressing method reflecting one aspect of the present invention is a contamination suppressing method executed in a droplet ejection apparatus including, a plurality of tanks that store liquid, a droplet ejection head that ejects droplets, a liquid channel that communicates between a first tank and a second tank on a downstream side of the first tank in a liquid delivery direction, and a liquid deliverer that delivers liquid from the first tank to the second tank, the method including:
controlling a liquid delivery speed of the liquid deliverer in accordance with an air amount present in the liquid channel.

According to another aspect of the present invention, a storage medium reflecting one aspect of the present invention is a non-transitory computer-readable storage medium storing a program executed on a computer of a droplet ejection apparatus including a plurality of tanks that store liquid, a droplet ejection head that ejects droplets, a liquid channel that communicates between a first tank and a second tank on a downstream side of the first tank in a liquid delivery direction, and a liquid deliverer that delivers liquid from the first tank to the second tank, the program causing the computer to function as:
a controller that controls a liquid delivery speed of the liquid deliverer in accordance with an air amount present in the liquid channel.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a cross-sectional side view of an inkjet recording apparatus;

FIG. 2 is a schematic configuration diagram of a liquid delivery section;

FIG. 3 is a schematic cross-sectional view of a liquid level sensor and a sub-tank; and

FIG. 4 is a block diagram of the inkjet recording apparatus.

### DETAILED DESCRIPTION

Hereinafter, one or more embodiments of the present invention will be described with reference to the drawings. However, the scope of the invention is not limited to the disclosed embodiments.

Hereinafter, a droplet ejection apparatus according to an embodiment of the present invention will be described in detail with reference to the drawings. However, the scope of the invention is not limited to the illustrated examples. In the following description, components having the same function and configurations are denoted by the same reference numerals, and the description thereof will be omitted.

### Overall Configuration of Inkjet Recording Apparatus

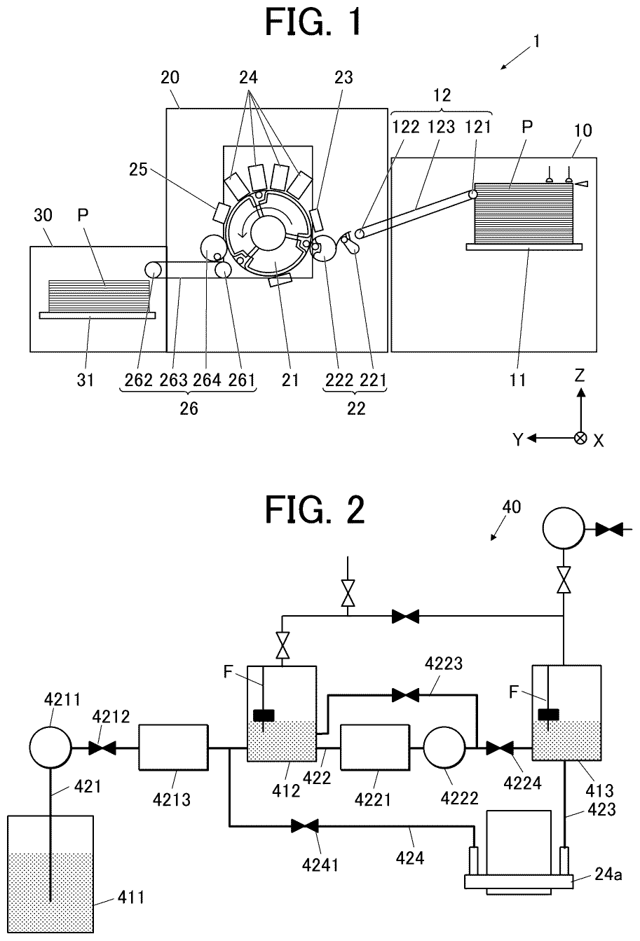

FIG. 1 is a cross-sectional side view of a main configuration of an inkjet recording apparatus 1 as an embodiment of a liquid droplet ejection apparatus of the present invention. The inkjet recording apparatus 1 includes a sheet feed section 10, an image forming section 20, a sheet ejection section 30, a liquid delivery section 40 (liquid deliverer) (see FIG. 2), and a controller (hardware processor) 50 (see FIG. 4).

The inkjet recording apparatus 1 conveys the recording medium P from the sheet feed section 10 to the image forming section 20 under the control of the controller 50. The controller 50 then causes the image forming section 20 to form images on the recording medium P with the ink supplied by the liquid delivery section 40. After image formation, the controller 50 ejects the recording medium P to the sheet ejection section 30.

Note that the recording medium P is not limited to paper such as plain paper and coated paper. As the recording medium P, various media capable of fixing the ink landed on the surface thereof, such as a textile or a sheet-shaped resin, can be used.

In the following description, an X direction, a Y direction, and a Z direction are directions illustrated in FIG. 1. In the following description, the X direction, the Y direction, and the Z direction are also referred to as a width direction, a conveyance direction, and a height direction, respectively.

### Sheet Feed Section

The sheet feed section 10 stores a recording medium P before image formation. The sheet feed section 10 conveys the recording medium P to the image forming section 20 under the control of the controller 50. The sheet feed section 10 includes a sheet feed tray 11 and a conveyance section 12.

### Sheet Feed Tray

The sheet feed tray 11 is a plate member that stores the recording medium P. The sheet feed tray 11 is provided such that one or a plurality of recording medium P can be placed thereon. The sheet feed tray 11 is moved upward and downward according to an amount of the recording medium P placed thereon. By the upward and downward movements, the sheet feed tray 11 is kept such that an uppermost recording medium P is conveyed by the conveyance section 12.

### Conveyance Section

The conveyance section 12 conveys the recording medium P from the sheet feed tray 11 to the image forming section 20. The conveyance section 12 includes a conveyance mechanism. The conveyance mechanism drives a belt 123 to convey the recording medium P on the belt 123. The belt 123 has a ring shape, and the inner side of the ring is supported by a plurality of rollers 121 and 122. The conveyance section 12 delivers the uppermost recording medium P placed on the sheet feed tray 11 onto the belt 123, and conveys the recording medium P along the belt 123.

### Image Forming Section

The image forming section 20 records an image on the recording medium P in cooperation with the liquid delivery section 40 under the control of the controller 50. The image forming section 20 includes an image forming drum 21, a handover unit 22, a sheet heating section 23, a head unit 24, an irradiation section 25, and a delivery section 26.

### Image Forming Drum

The image forming drum 21 holds the recording medium P along its cylindrical outer periphery surface and rotates to convey the recording medium P. The conveyance surface of the image forming drum 21 faces the sheet heating section 23, the head unit 24, and the irradiation section 25, which perform image formation processing on the conveyed recording medium P.

### Handover Unit

The handover unit 22 is provided between the conveyance section 12 and the image forming drum 21. The handover unit 22 includes a claw 221 and a handover drum 222.

The claw 221 is a cylindrical part that holds one end of the recording medium P conveyed by the conveyance section 12. The handover drum 222 guides the recording medium P held by the claw 221.

The handover unit 22 picks up the recording medium P on the conveyance section 12 with the claw 221 and places the recording medium P along the outer periphery surface of the handover drum 222. Thus, the handover unit 22 passes the recording medium P to the image forming drum 21.

### Sheet Heating Section

The sheet heating section 23 includes, for example, a heating wire and generates heat by energization. The sheet heating section 23 is controlled by the controller 50 to generate heat so that the recording medium P passing in the vicinity of the sheet heating section 23 has a predetermined temperature. The sheet heating section 23 is provided in the vicinity of the outer peripheral surface of the image forming drum 21 and on the upstream side of the head unit 24 in the conveyance direction of the recording medium P.

A temperature sensor (not illustrated) is provided near the sheet heating section 23. With the temperature sensor, the controller 50 detects the temperature around the sheet heating section 23. Based on the detected temperature, the controller 50 controls heat generation of the sheet heating section 23.

### Head Unit

The head unit 24 includes, for example, a plurality of inkjet heads and a carriage on which the inkjet heads are mounted. The head unit 24 ejects ink droplets from nozzles onto the recording medium P to form the image. The head units 24 corresponding to the colors of C (cyan), M (magenta), Y (yellow), and K (black) are provided. In FIG. 1, the head units 24 corresponding to the colors of Y, M, C, and K are provided in this order from the upstream of the conveyance direction of the recording medium P.

A plurality of head units 24 according to the present embodiment are arranged so as to be in a length (width) that covers the entire width of the recording medium P in the width direction. That is, the inkjet recording apparatus 1 is a one-pass line-head type inkjet recording apparatus. Each of the head units 24 includes an array of a plurality of inkjet heads 24a (see FIG. 2), which are droplet ejection heads. The number of the head unit 24 may be five or more or three or less. Further, one inkjet head 24a may constitute one head unit 24.

The ink jetted by the head unit 24 is, for example, ultraviolet curable ink (UV ink). The ultraviolet curable ink contains, for example, an ultraviolet curable resin. The ultraviolet curable resin contains a monomer and a polymerization initiator. When the ink containing the ultraviolet curable resin is irradiated with ultraviolet rays, the monomer is polymerized and cured by the action of the polymerization initiator, and the ink is fixed to the recording medium P.

The ink ejected by the head unit 24 may be gel ink containing a gelling agent. The gel ink changes in phase between a gel state and a liquid (sol) state depending on the temperature. The gel ink has a phase change temperature of, for example, about 40 to 100° C., and is uniformly liquefied (solated) by being heated to the phase change temperature or higher. On the other hand, the gel ink is gelled at about normal room temperature, that is, about 0 to 30° C. Therefore, the ink in the head unit 24 is heated to an appropriate temperature by an ink heater or the like (not illustrated) to be brought into a sol state. Then, after being ejected and landed on the recording medium P, the ink is moderately transferred to a gel state while being conveyed by the image forming drum 21.

### Irradiation Section

The irradiation section 25 includes, for example, a fluorescent tube such as a low-pressure mercury lamp. The irradiation section 25 emits energy rays such as ultraviolet rays by light emission of the fluorescent tube. The irradiation section 25 is provided in the vicinity of the outer periphery surface of the image forming drum 21. The irradiation section 25 is positioned downstream of the head unit 24 in the conveyance direction of the recording medium P. The irradiation section 25 emits energy rays to the recording medium P on which the ink has been ejected. When the ink on the recording medium P is UV ink, the ink is cured by the action of the energy rays.

The fluorescent tube that emits ultraviolet rays is not limited to a low-pressure mercury lamp. The fluorescent tube may be a mercury lamp having an operating pressure of a few hundred Pa to 1 MPa, for example. The fluorescent tube may be a light source usable as a bactericidal lamp, for example, a cold-cathode tube, an ultraviolet laser light source, a metal halide lamp, a light-emitting diode, or the like. The fluorescent tube is desirably a power saving light source capable of emitting ultraviolet light with higher illuminance. The fluorescent tube is, for example, a light emission diode. The energy rays are not limited to the ultraviolet rays and may be energy rays having a property of curing the ink depending on the property of the ink.

The light source is determined depending on the energy rays.

In the above description, the case where the head unit 24 discharges the ultraviolet curable ink or the ink containing the gelling agent is exemplified, but the invention is not limited thereto. The ink ejected by the head unit 24 may be water-based ink or ink having other physical properties.

### Delivery Section

The delivery section 26 includes a conveyance mechanism. The conveyance mechanism drives a ring-shaped belt 263 to convey the recording medium P. The inner side of the belt 263 is supported by a plurality of rollers 261 and 262. The delivery section 26 includes a cylindrical handover roller 264. The handover roller 264 passes the recording medium P from the image forming drum 21 to the conveyance mechanism. The delivery section 26 conveys and sends the recording medium P passed on the belt 263 by the handover roller 264 to the sheet ejection 25 section 30.

### Sheet Ejection Section

The recording medium P on which the image is formed by the image forming section 20 is ejected to the sheet ejection section 30. The sheet ejection section 30 includes a plate-shaped sheet ejection tray 31. The recording medium P sent out from the image forming section 20 by the delivery section 26 is placed on the sheet ejection tray 31. The sheet ejection section 30 stores the recording medium P until a user takes out the recording medium P.

### Liquid Delivery Section

FIG. 2 shows a schematic configuration of the liquid delivery section 40. FIG. 2 shows only one inkjet head 24a, and other plurality of inkjet heads 24a are omitted. The liquid delivery section 40 includes a tank 41, a liquid channel 42, and the like (see FIG. 4 showing both).

### Tank

The tank 41 stores ink therein. The tank 41 is made of, for example, metal, and has a rigid sealed structure. The tank 41 includes a main tank 411, a first sub-tank 412, and a second sub-tank 413.

### Main Tank

The main tank 411 stores each color ink to be supplied to each portion of the liquid delivery section 40. Although omitted in FIG. 2, the main tank 411 is provided individually for each color of ink. The ink is supplied to an inkjet head 24a via a first liquid channel 421, the first sub-tank 412, a second liquid channel 422, the second sub-tank 413, and a third liquid channel 423, which will be described later. The entire body of the main tank 411 is replaceable, and the main tank 411 is formed so as to be attachable to and detachable from the first liquid channel 421 regardless of the operating status of a first liquid delivery section 4211 which will be described later.

### First Sub-Tank

The first sub-tank 412 temporarily stores the ink supplied from the main tank 411. Since the liquid delivery section 40 includes the first sub-tank 412, a pressure change due to pulsation when the first liquid delivery section 4211 supplies the ink of the main tank 411 is alleviated. The ink that is not discharged from the inkjet head 24 is collected to the first sub-tank 412 from an outlet.

### Second Sub-Tank

The second sub-tank 413 temporarily stores the ink to be delivered to the inkjet head 24a. The second sub-tank 413 is provided with a back pressure adjustment means (not illustrated). The back pressure adjustment means applies appropriate negative pressure to the inkjet head 24a to prevent ink from leaking out of the inkjet head 24a.

Note that in the following description, the first sub-tank 412 and the second sub-tank 413 will be simply referred to as “sub-tank” unless otherwise distinguished from each other.

### Liquid Level Sensor

The sub-tanks are each provided with a liquid level sensor F (measurer). The liquid level sensor F measures information on the amount of ink in the attached sub-tank. Specifically, the liquid level sensor F measures a liquid level position in the sub-tank and transmits the data to the controller 50. The controller 50 acquires a liquid level height in the sub-tank based on the data.

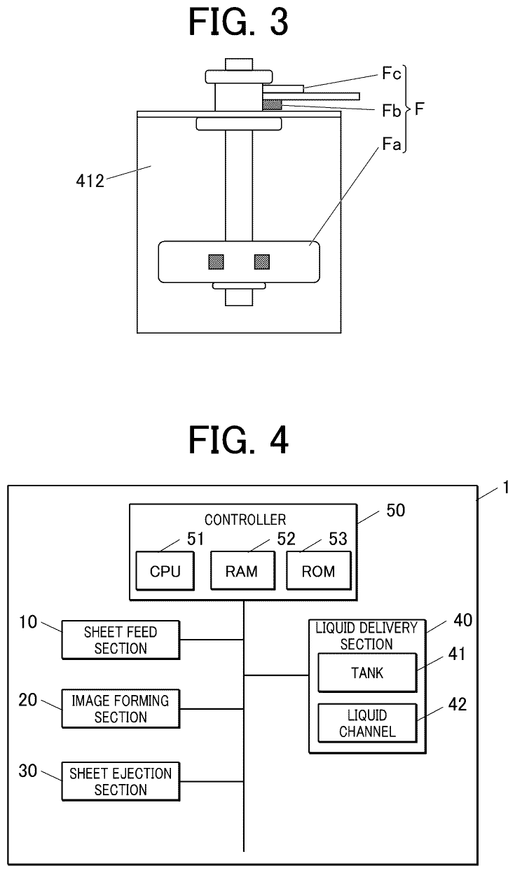

A detailed configuration of the liquid level sensor F according to the present embodiment is illustrated in FIG. 3. As illustrated in FIG. 3, for example, the liquid level sensor F is a float sensor including a float Fa, a magnetic sensor Fb, and a magnetic body Fc.

The float Fa is provided in the sub-tank. A magnet is built in the float Fa. The float Fa moves up and down in accordance with an increase or decrease of the ink in the sub-tank to generate a magnetic field. The magnetic sensor Fb is provided at the top of the sub-tank. The magnetic sensor Fb measures a magnetic flux density of the magnetic field that changes according to whether the float Fa moves up or down. The magnetic sensor Fb measures the liquid level height in the sub-tank. The magnetic body Fc is provided in the vicinity of the magnetic sensor Fb. The magnetic body Fc concentrates the magnetic flux on the sensor Fb, thereby improving the sensitivity thereof. As described above, the liquid level sensor F according to the present embodiment is a magnetic sensor that measures information on the amount of ink by magnetism.

The magnetic sensor Fb may be provided on a side surface portion of the sub-tank. However, it is preferable to provide the magnetic sensor Fb at an upper part of the sub-tank because its sensitivity is improved.

Furthermore, the liquid level sensor F for measuring the liquid level height in the sub-tank is not limited to the float sensor including the float Fa and the magnetic sensor Fb. For example, the liquid level height in the sub-tank may be measured by a capacity sensor using an electric field.

Furthermore, although the first sub-tank 412 is illustrated in FIG. 3, the liquid level sensor F is also attached to the second sub-tank 413 in a similar manner.

Furthermore, the sub-tank is provided with an ink heating section (not illustrated) that holds the ink inside at an appropriate temperature. The ink heating section is constituted of a heater, a heat transfer member that transfers heat of the heater, and the like. As the heater constituting the ink heating section, a heating wire that generates Joule heat by energization is used, for example. As the heat transfer member constituting the ink heating section, a member having a high heat conductivity, such as a heat conductive plate formed of various metals (alloys) is used, for example.

Further, the sub-tank is provided with a pressure sensor capable of measuring an internal pressure value and an air path as shown in FIG. 2. The air path is provided with a pneumatic pump (not illustrated) capable of sucking and depressurizing the air in each sub-tank under the control of the controller 50, and the pressure in each sub-tank is controlled.

In particular, the controller 50 makes the pressure in the first sub-tank 412 higher than the pressure in the second sub-tank 413 by, for example, sending air from the second sub-tank 413 to the first sub-tank 412, and sends the ink in the first sub-tank 412 to the second sub-tank 413. More specifically, in a state where the liquid amount in the first sub-tank 412 is larger than a predetermined lower limit value, when the liquid amount in the second sub-tank 413 reaches a predetermined lower limit value, the ink in the first sub-tank 412 is delivered to the second sub-tank 413 by the above-described control by the controller 50.

### Liquid Channel

The liquid channel 42 is an ink channel that communicates from the main tank 411 to the inkjet head 24a so as to enable a return flow. The liquid channel 42 includes the first liquid channel 421, the second liquid channel 422, the third liquid channel 423, and a fourth liquid channel 424. The liquid channel 42 preferably has ink resistance, and has a hollow annular tube structure.

### First Liquid Channel

The first liquid channel 421 allows the main tank 411 and the first sub-tank 412 to communicate with each other. The first liquid channel 421 is provided with a first liquid delivery section 4211, a supply valve 4212, and a dissolving section 4213.

### First Liquid Delivery Section

The first liquid delivery section 4211 sends the ink in the main tank 411 to the first sub-tank 412. If the controller 50 detects, as a result of the measurement by the first liquid level sensor F1, that the liquid amount in the first sub-tank 412 is the predetermined lower limit value, the controller 50 drives the first liquid delivery section 4211 for a predetermined amount of time to deliver the ink in the main tank 411 to the first sub-tank 412.

The first liquid delivery section 4211 is, for example, a pump, but is not limited thereto. In a case where the first liquid delivery section 4211 is the pump, a diaphragm pump is preferable from the viewpoints of durability, cost, size, abundance of types, and the like.

### Supply Valve

The supply valve 4212 is, for example, an electromagnetic valve. Under the control of the controller 50, the supply valve 4212 selectively opens the first liquid channel 421 when the first liquid delivery section 4211 is driven.

### Dissolving Section

The dissolving section 4213 is, for example, an ink heater or the like. Under the control of the controller 50, the dissolving section 4213 heats the ink flowing through the first liquid channel 421 to a predetermined temperature to lower a viscosity of the ink.

### Second Liquid Channel

The second liquid channel 422 is a channel that allows the first sub-tank 412 and the second sub-tank 413 to communicate with each other. The second liquid channel 422 is provided with a deaeration module 4221, a second liquid delivery section 4222, a circulation channel 4223, and a circulation valve 4224.

### Deaeration Module

The deaeration module 4221 includes, for example, a gas permeable film that is depressurized by being brought into an airtight state and then sucking the air inside. Next, the gas permeable film is brought into contact with the ink, so that the dissolved gas in the ink permeates the gas permeable film due to a pressure difference, and the dissolved gas in the ink that has passed through is removed.

### Second Liquid Delivery Section

The second liquid delivery section 4222 sends the ink in the first sub-tank 412 to the second sub-tank 413. If the controller 50 detects, as a result of measurement by the second liquid level sensor F2, that the liquid amount in the second sub-tank 413 is the predetermined lower limit value, the controller 50 drives the second liquid delivery section 4222 for a predetermined amount of time to deliver the ink in the first sub-tank 412. The second liquid delivery section 4222 is preferably particularly a diaphragm pump in a case of a pump for the same reason as the first liquid delivery section 4211

### Circulation Channel

The circulation channel 4223 is a channel provided so as to branch from the downstream side of the second liquid delivery section 4222 in a liquid sending direction and from the upstream side of the circulation valve 4224 in the liquid sending direction. The circulation channel 4223 includes a channel that communicates with the first liquid channel 421 between the supply valve 4212 and the dissolving section 4213. With the above-described configuration, when the controller 50 closes the circulation valve 4224 and drives the second liquid delivery section 4222, the ink delivered from the first sub-tank 412 passes through the dissolving section 4213 and returns to the first sub-tank 412. Therefore, when the supply of the ink is stopped, it is possible to suppress a decrease in the temperature of the ink and the occurrence of unevenness in the temperature.

### Circulation Valve

The circulation valve 4224 is an electromagnetic valve, and selectively opens the second liquid channel 422 when the second liquid delivery section 4222 is driven.

Note that a known deaeration module to remove air in the ink, a known filter to collect foreign substance in the ink, and the like may be further provided on the upstream side in the liquid delivery direction from the second liquid delivery section 4222 in the second liquid channel 422. Providing these configurations can suppress deterioration of the second liquid delivery section 4222. Furthermore, foreign substance in the ink can be removed when the ink is circulated as described above.

### Third Liquid Channel And Fourth Liquid Channel

The third liquid channel 423 is a channel that communicates between the second sub-tank 413 and an inlet of the inkjet head 24a. In addition, the fourth liquid channel 424 is a channel that allows the outlet of the inkjet head 24a and the first sub-tank 412 to communicate with each other. The fourth liquid channel 424 is provided with a second circulation valve 4241 which is an electromagnetic valve. The second circulation valve 4241 selectively opens the fourth liquid channel 424 when the ink is circulated from the inkjet head 24a to the first sub-tank 412, under the control of the controller 50.

### Controller

FIG. 4 is a block diagram illustrating a configuration of the inkjet recording apparatus 1. The controller 50 controls each section constituting the inkjet recording apparatus 1. As shown in FIG. 4, the controller 50 is connected to each section constituting the inkjet recording apparatus 1. The controller 50 includes a central processing unit (CPU) 51, a random access memory (RAM) 52, and a read only memory (ROM) 53.

The CPU 51 reads various programs and data corresponding to processing contents from the storage device of the ROM 53 or the like and executes them. Further, the CPU 51 controls the operation of the components constituting the inkjet recording apparatus 1 according to the contents of the executed processing. The RAM 52 temporarily stores therein the various programs and program processed by the CPU 51. The ROM 53 is a non-volatile storage device such as a hard disk drive (HDD), a solid state drive (SSD), or a flash memory, and stores various programs and data read by the CPU 51 or the like.

### Bubble Generation Suppression Processing

In the liquid delivery section 40 as described above, when the ink is delivered, if air is present in the tank 41 or the liquid channel 42 on the downstream side, the air is dissolved in the liquid. Then, when the liquid is heated by, for example, an ink heating section (not illustrated) provided in the tank 41, the air is discharged as bubbles.

When the bubbles are generated in the tank, the density of the liquid decreases, and a buoyant force acting on the float Fa decreases. Therefore, the liquid level sensor F may erroneously detect the liquid level height of the tank. In addition, when bubbles are generated in the tank, a ventilation path may be contaminated by liquid splash.

Therefore, when the liquid is delivered from the first tank on the upstream side to the second tank on the downstream side in the liquid delivery direction, the controller 50 controls the liquid delivery speed of the liquid delivery section in accordance with the amount of air or an equivalent value equivalent to the amount of air present in the liquid channel 42 communicating between both tanks 41 and the second tank on the downstream side.

### EXAMPLE

Hereinafter, the control of the liquid delivery speed of the liquid delivery section by the controller 50 will be specifically described based on examples and the like. However, the present invention is not limited to the following specific example.

### Test 1

In the inkjet recording apparatus 1 including the liquid delivery section 40 as illustrated in FIG. 2, the ink was sent from the main tank 411 at different liquid delivery speeds (a, 2a, 4a (cc/sec)) for different liquid delivery times (t, 2 t, 4 t, 6 t (sec)) by the first liquid delivery section 4211. Then, ink foaming in the first sub-tank 412 was visually evaluated. Note that the sum of the flow path volumes of the first liquid channel 421 and the first sub-tank 412 is α(cc), which satisfies α=4at.

### Test 2

In the same inkjet recording apparatus 1 as in Test 1, the ink was delivered from the main tank 411 at the speed a for 4 t seconds by the first liquid delivery section 4211 to fill the first liquid channel 421 and the first sub-tank 412 with the ink. Thereafter, the ink was sent at different speeds (a, 2a, 4a (cc/sec)) for different liquid delivery times (t, 2 t, 4 t, 6 t (sec)), and bubbling of the ink in the first sub-tank 412 was visually evaluated.

In the evaluation of foaming in both tests, a case where foaming could not be confirmed in the first sub-tank 412 was rated as G (Good), and a case where foaming could be confirmed was rated as NG (Not Good). In addition, “-” indicates a state where the first sub-tank 412 is not filled with ink.

The results of Test 1 are shown in Table I and the results of Test 2 are shown in Table II.

TABLE I

| | |
|---|---|
| LIQUID DELIVERY | LIQUID DELIVERY SPEED (cc/s) |

| TIME (s) | a | 2a | 4a |
|---|---|---|---|
| t | — | — | NG |
| 2t | — | NG | NG |
| 4t | G | NG | G |
| 6t | G | G | G |

TABLE II

| | |
|---|---|
| LIQUID DELIVERY | LIQUID DELIVERY SPEED (cc/s) |

| TIME (s) | a | 2a | 4a |
|---|---|---|---|
| t | G | G | G |
| 2t | G | G | G |
| 4t | G | G | G |
| 6t | G | G | G |

From Table I, it is found that ink foaming can be suppressed by the controller 50 controlling the liquid delivery speed of the liquid delivery section to be low until the integrated liquid delivery amount of ink is 4at, and the air amount in the first liquid channel 421 and first sub-tank 412 becomes 0.

On the other hand, from Table I, when the liquid delivery time becomes 6t it is found that the foaming generation in the first sub-tank 412 is suppressed.

This is because, in the present embodiment, when the liquid delivery speed is 2a or more and the liquid delivery time is 6t, the first liquid channel 421 and the first sub-tank 412 are filled with ink and no air exists therein. Therefore, it is found that even when the controller 50 controls the liquid delivery speed based on the elapsed time from the start of the liquid delivery from the main tank 411 on the upstream side to the first sub-tank 412 on the downstream side, the generation of the foaming in the first sub-tank 412 can be suppressed.

Specifically, until the first liquid channel 421 and the first sub-tank 412 are filled with the ink, the liquid delivery speed is preferably controlled such that the ratio of the liquid delivery amount per unit time to the sum of the volumes of the first liquid channel 421 and the first sub-tank 412 is 0.1 or less.

Furthermore, it is found from Table II that after the ink has filled the first liquid channel 421 and the first sub-tank 412, the occurrence of foaming can be suppressed without controlling the liquid delivery speed. This is because the air existing in the first liquid channel 421 and the first sub-tank 412 is replaced with the ink, and the air does not dissolve in the ink. Therefore, it is preferable that the liquid is delivered at a low speed (liquid delivery speed a) until the liquid delivery time becomes 4t, and the liquid is delivered at an arbitrary liquid delivery speed after the liquid delivery time exceeds 4t.

### Effects of Embodiment

As described above, the inkjet recording apparatus 1, which is the droplet ejection apparatus according to the present embodiment, includes the plurality of tanks 41 that store ink, and the liquid channel 42 that provides communication between the first tank and the second tank located on the downstream side of the first tank in the liquid delivery direction. The inkjet recording apparatus 1 further includes the controller 50 that controls the liquid delivery speed of the liquid delivery section in accordance with the amount of air present in the liquid channel 42 and the downstream tank or an equivalent value equivalent to the amount of air. According to the configuration, it is possible to suppress the occurrence of foaming in the second tank, and to suppress contamination due to the liquid splash.

In particular, when the liquid ejected by the droplet ejection apparatus is UV ink or gel ink, bubbling is more likely to occur than in the case of other liquids. However, according to the above-described configuration, the occurrence of foaming can be suppressed.

### Modification Example and the Like

Although specific descriptions have been given above on the basis of the embodiment according to the present invention, the present invention is not limited to the above-described embodiment. The present invention can be subjected to various modifications within the scope of the invention described in the claims and the equivalents thereof.

For example, in the above description, the controller 50 controls the liquid delivery speed based on the integrated liquid delivery amount, but in a case where the first sub-tank 412 on the downstream side includes the liquid level sensor F, the measurement result is substantially equal to the integrated liquid delivery amount. Therefore, the controller 50 may control the liquid delivery speed based on the measurement result of the liquid level sensor F.

Furthermore, in the description above, after the ink has filled the first liquid channel 421 and the first sub-tank 412, the occurrence of foaming can be suppressed without controlling the liquid delivery speed, but when all of the ink in the liquid delivery section 40 is discharged by, for example, purging or the like, air enters the liquid delivery section 40 again. Therefore, in a case where all of the ink in the liquid delivery section 40 is discharged, it is preferable to suppress foaming of the ink by performing control again by resetting various equivalent values (the liquid delivery time, the integrated liquid delivery amount, or the measurement result of the liquid level sensor F) equivalent to the amount of air in the tank 41 and the liquid channel 42.

Furthermore, although the case where the present invention is applied to the inkjet recording apparatus 1 that ejects ink has been mainly illustrated above, the droplet ejection apparatus is not limited to the inkjet recording apparatus 1. That is, the configuration of the present invention is applicable to the droplet ejection apparatus to eject not only ink but also other liquids.

Furthermore, although an example in which the main tank 411 is the first tank and generation of bubbles is suppressed when liquid is fed to the first sub-tank 412 that is the second tank has been described above, it is not limited thereto. For example, in a case where the second liquid channel 422 does not include the deaeration module 4221, the configuration of the present invention is applicable also in a case of delivering liquid from the first sub-tank 412 to the second sub-tank 413, with the first sub-tank 412 as the first tank and the second sub-tank 413 as the second tank.

Furthermore, the case where the first liquid delivery section 4211 and the second liquid delivery section 4222 are pumps has been exemplified in the description above, but it is not limited thereto.

In the above description, an example in which a hard disk, a semiconductor non-volatile memory, or the like is used as a computer-readable medium for the program according to the present invention has been disclosed, but the medium is not limited to this example. As another computer-readable medium, a portable recording medium such as a CD-ROM can be applied. Furthermore, a carrier wave is also applied as a medium for providing data of the program according to the present invention via a communication line.

Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2024-094775, filed on Jun. 12, 2024, including description, claims, drawings and abstract is incorporated herein by reference.

What is claimed is:

1. A droplet ejection apparatus comprising:
a plurality of tanks that store liquid;
a droplet ejection head that ejects droplets;
a liquid channel that communicates between a first tank and a second tank on a downstream side of the first tank in a liquid delivery direction;
a liquid deliverer that delivers liquid from the first tank to the second tank; and
a hardware processor that controls a liquid delivery speed of the liquid deliverer in accordance with an air amount present in the liquid channel and the second tank or an equivalent value equivalent to the air amount.

2. The droplet ejection apparatus according to claim 1, wherein the hardware processor controls the liquid delivery speed based on, as the equivalent value, an elapsed time from a start of a delivery of the liquid from the first tank to the second tank.

3. The droplet ejection apparatus according to claim 2, wherein the hardware processor controls the liquid delivery speed such that the liquid delivery speed before the elapsed time reaches a predetermined value is lower than the liquid delivery speed after the elapsed time reaches the predetermined value.

4. The droplet ejection apparatus according to claim 3, wherein the hardware processor is configured to, before the elapsed time reaches the predetermined value, control the liquid delivery speed such that a ratio of the liquid delivery speed to a sum of a volume of the liquid channel and a volume of the second tank is 0.1 or less.

5. The droplet ejection apparatus according to claim 2, wherein the hardware processor resets the elapsed time in a case in which all of the liquid in the second tank and the liquid channel is discharged.

6. The droplet ejection apparatus according to claim 1, wherein the hardware processor controls the liquid delivery speed based on, as the equivalent value, an integrated liquid delivery amount from a start of a delivery of the liquid from the first tank to the second tank.

7. The droplet ejection apparatus according to claim 6, wherein the hardware processor controls the liquid delivery speed such that the liquid delivery speed before the integrated liquid delivery amount reaches a predetermined value is lower than the liquid delivery speed after the integrated liquid delivery amount reaches the predetermined value.

8. The droplet ejection apparatus according to claim 7, wherein the hardware processor is configured to, before the integrated liquid delivery amount reaches the predetermined value, control the liquid delivery speed such that a ratio of the liquid delivery speed to a sum of a volume of the liquid channel and a volume of the second tank is 0.1 or less.

9. The droplet ejection apparatus according to claim 6, wherein the hardware processor resets the integrated liquid delivery amount in a case in which all of the liquid in the second tank and the liquid channel is discharged.

10. The droplet ejection apparatus according to claim 1,
further comprising a measurer that measures a liquid amount in the second tank,
wherein the hardware processor controls the liquid delivery speed based on a measurement result of the measurer.

11. The droplet ejection apparatus according to claim 10, wherein the hardware processor controls the liquid delivery speed such that the liquid delivery speed before the liquid amount reaches a predetermined value is lower than the liquid delivery speed after the liquid amount reaches the predetermined value.

12. The droplet ejection apparatus according to claim 11, wherein the hardware processor is configured to, before the liquid amount reaches the predetermined value, control the liquid delivery speed such that a ratio of the liquid delivery speed to a sum of a volume of the liquid channel and a volume of the second tank is 0.1 or less.

13. The droplet ejection apparatus according to claim 10, wherein the hardware processor resets the measurement result of the measurer in a case in which all of the liquid in the second tank and the liquid channel is discharged.

14. The droplet ejection apparatus according to claim 1, wherein the liquid is UV ink.

15. The droplet ejection apparatus according to claim 1, wherein the liquid is gel ink.

16. A contamination suppressing method executed in a droplet ejection apparatus including, a plurality of tanks that store liquid, a droplet ejection head that ejects droplets, a liquid channel that communicates between a first tank and a second tank on a downstream side of the first tank in a liquid delivery direction, and a liquid deliverer that delivers liquid from the first tank to the second tank, the method comprising:
controlling a liquid delivery speed of the liquid deliverer in accordance with an air amount present in the liquid channel.

17. A non-transitory computer-readable storage medium storing a program executed on a computer of a droplet ejection apparatus including a plurality of tanks that store liquid, a droplet ejection head that ejects droplets, a liquid channel that communicates between a first tank and a second tank on a downstream side of the first tank in a liquid delivery direction, and a liquid deliverer that delivers liquid from the first tank to the second tank, the program causing the computer to function as:
a controller that controls a liquid delivery speed of the liquid deliverer in accordance with an air amount present in the liquid channel.
